(19) United States
(12) Patent Application Publication
(10) Pub. No.: US 2010/0144177 A1
(43) Pub. Date: Jun. 10, 2010

(54) ELECTRICAL CONNECTOR WITH INTERLOCKING FEATURES

(75) Inventors: Brian VICICH, Prospect, KY (US); Kevin MEREDITH, Loretto, KY (US)

Correspondence Address: SAMTEC INCORPORATED;C/O KEATING & BENNETT, LLP, 1800 Alexander Bell Drive, SUITE 200, Reston, VA, 20191, US

(73) Assignee: Samtec, Inc., New Albany, IN (US)

(21) Appl. No.: 12/328,079

(22) Filed: Dec. 4, 2008

(51) Int. Cl. H01R 25/00

(52) U.S. Cl. 439/117

(57) ABSTRACT

An electrical connector includes a first connector module having at least one electrical contact and having a male mechanical connector and a second connector module having at least one electrical contact and having a female mechanical connector. The male mechanical connector and the female mechanical connector are arranged to connect the first connector module and the second connector module to one another. The male mechanical connector includes an alignment rail and a locking projection. The female mechanical connector includes an alignment slot and a locking channel. The alignment rail and the alignment slot are engaged with each other. The locking projection and the locking channel are engaged with each other.

### BACKGROUND OF THE INVENTION

1. Field of the Invention

The present invention generally relates to an electrical connector. More specifically, the present invention relates to interlocking features that connect independent, modular electrical connectors together without a large amount of assembly force or without the use of any specialized tools.

2. Description of the Related Art

It is known that electrical connectors are designed with various sizes and shapes and with different mechanical and electrical characteristics. For example, depending on the particular application, an electrical connector might require signal contacts, power contacts, or a combination of signal and power contacts. A typical approach for a particular application is to design a unitary electrical connector that satisfies the specific requirement of that particular application. A problem with designing a unitary electrical connector is the length of time it takes to completely design the unitary electrical connector because of the complexity in having to ensure that all of the specific requirements of a particular application are satisfied.

It is also known to use modular designs instead of a unitary design. That is, instead of designing a unitary electric connector, it is known to design an electrical connector by combining different connector modules that provide different specific requirements of the particular application. For example, if a particular application requires signal contacts and power contacts, it is known to combine a connector module having signal contacts with a connector module having power contacts.

In modular design, connector modules are interconnected by securing features in adjacent sides of neighboring connector modules. After the connector modules have been placed in a desired arrangement, the connector modules are permanently interconnected by crimping one body (e.g., EMI shield) about a receiving feature of another body, by clipping, by interference fit, or by encapsulation of the connector modules within a curable plastic or resin.

U.S. Pat. No. 7,361,055 shows connector modules that are connected by dovetailed features located on the ends of the connector modules. As is described in column 4, lines 19-25 of U.S. Pat. No. 7,361,055, once a desired arrangement of connector modules is completed, the entire array is encapsulated with a curing resin or plastic to ensure that the modules remain rigidly attached to one another in the desired arrangement.

Conventional connector modules typically require specialized tools to join together to form an electrical connector and require a large assembly force to form a desired arrangement, which leads to both increased manufacturing time and increased costs. Further, with conventional connector modules it is difficult to precisely arrange the conventional connector modules with respect to each other.

### SUMMARY OF THE INVENTION

To overcome the problems described above, preferred embodiments of the present invention provide an electrical connector that includes connector modules having interlocking features that connect the connector modules together without any specialized tool or a large assembly force.

An electrical connector according to a preferred embodiment of the present invention includes a first connector module having at least one electrical contact and having a male mechanical connector and a second connector module having at least one electrical contact and having a female mechanical connector. The male mechanical connector and the female mechanical connector are arranged to connect the first connector module and the second connector module to one another. The male mechanical connector includes an alignment rail and a locking projection. The female mechanical connector includes an alignment slot and a locking channel. The alignment rail and the alignment slot are engaged with each other. The locking projection and the locking channel are engaged with each other.

The alignment rail is preferably arranged adjacent to the locking projection on an end surface of the first connector module. Preferably, the male mechanical connector further includes a resilient engagement arm having an engagement edge, where a void is provided between the engagement edge and an end surface of the first connector module. Each of the locking rail and the locking projection preferably include a tapered end. The alignment slot is preferably arranged adjacent to the locking channel on an end surface of the second connector module.

Preferably, the locking channel includes a locking tab located on an inner surface of the locking channel and at least one guide projection on the inner surface of the locking channel. The at least one guide projection preferably includes a tapered end.

The locking channel preferably has a T or a dovetailed shape. At least one of the first connector module and second connector module preferably includes a plurality of signal contacts. The plurality of signal contacts is preferably arranged in a single-ended array or in a differential pair array. At least one of the first connector modules and the second connector module preferably includes a plurality of power contacts. The locking tab preferably has a wedge shape.

Preferably, an edge of the locking projection engages the edge of the locking tab such the first connector module and the second connector module are prevented from being moved with respect to each other. The locking channel preferably includes at least one stopping surface. Preferably, at least one retaining surface of the locking projection engages the at least one stopping surface of the locking channel such the first connector module and the second connector module are prevented from being moved with respect to each other. Preferably, at least one of the first connector module and the second connector module includes at least one guide post arranged to ensure proper alignment with another electrical connector.

At least one of the first connector module and second connector module preferably includes at least one alignment pin arranged to ensure proper alignment with a circuit board. The at least one electrical contact of the first connector module or the second connector module preferably includes solder. The at least one electrical contact of the first connector module or the second connector module preferably includes legs that are arranged to be inserted into through holes of a circuit board.

An electrical connector system according to a preferred embodiment of the present invention includes an electrical connector of a preferred embodiment of the present invention and a circuit board.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is a perspective view of an electrical connector according to a preferred embodiment of the present invention.

FIG. 2 is a top view of a connector module having female interlocking features in accordance with a preferred embodiment of the present invention.

FIG. 3 is a top view of a connector module having male interlocking features in accordance with a preferred embodiment of the present invention.

FIG. 4 is a close-up perspective view showing the details of the female interlocking features of a connector module in accordance with a preferred embodiment of the present invention.

FIG. 5 is a perspective view showing the details of the male interlocking features of a connector module in accordance with a preferred embodiment of the present invention.

FIG. 6 is a side perspective view showing additional details of the male interlocking features of a connector module in accordance with a preferred embodiment of the present invention.

FIG. 7 is a sectional view showing a connection between the male and female interlocking features of the connector modules according to a preferred embodiment of the present invention.

FIG. 8 is a perspective view showing an electrical connector according to a preferred embodiment of the present invention mounted to a circuit board.

FIG. 9 is a bottom perspective view showing the details of a bottom of a module according to a preferred embodiment of the preferred invention.

FIG. 10 is a perspective view of a partially assembled male electrical connector according to a preferred embodiment of the present invention.

FIG. 11 is perspective view of a partially assembled female electrical connector according to a preferred embodiment of the present invention mated with a male electrical connector according to another preferred embodiment of the present invention.

### DETAILED DESCRIPTION OF PREFERRED EMBODIMENTS

Preferred embodiments of the present invention will be discussed below with reference to respective figures. Similar features will be labeled using the same reference numbers in all of the figures.

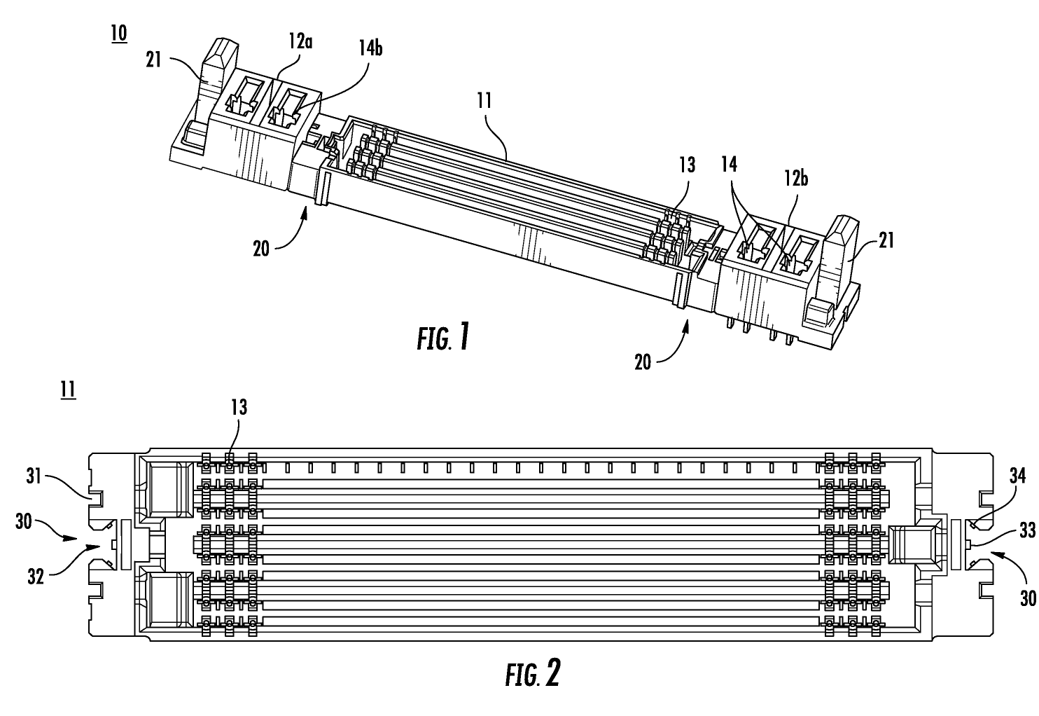

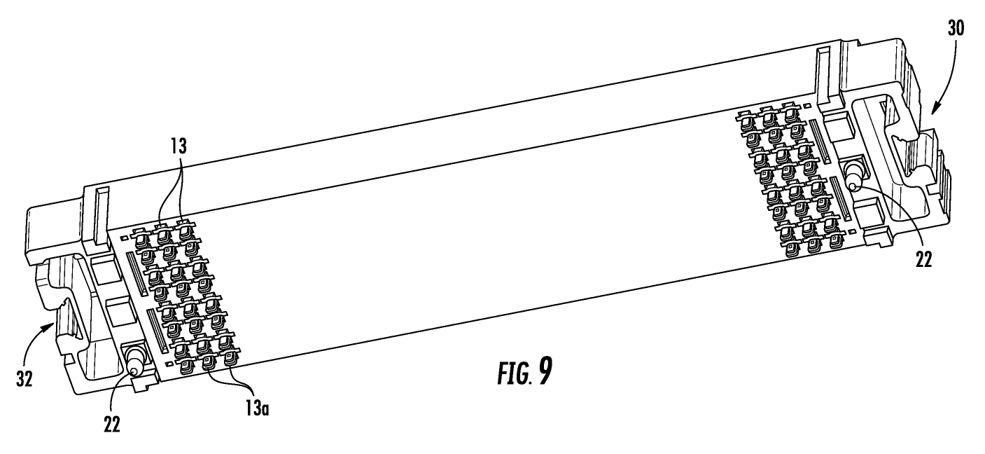

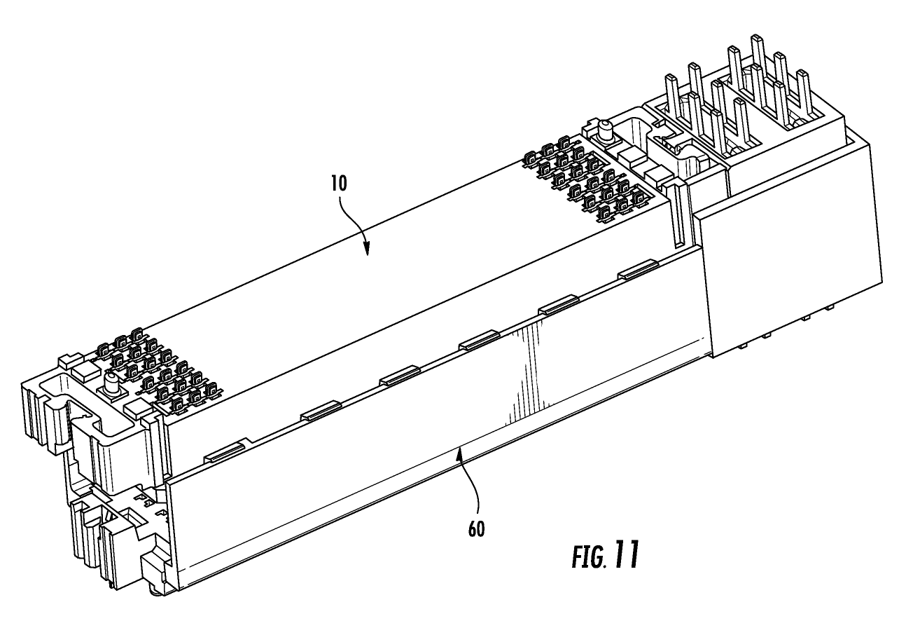

As shown in FIG. 1, an electrical connector 10 according to preferred embodiments of the present invention includes a plurality of connector modules connected to each other. The electrical connector 10 shown in FIGS. 1 and 8 is a female electrical connector. A corresponding partially assembled male electrical connector 60 is shown in FIG. 10. The connector modules can include different types of connector modules that provide different functionality. As shown in FIG. 1, the connector modules preferably include a signal module 11 and a power module 12a or 12b.

The electrical connector 10 preferably includes signal contacts 13 and power contacts 14. FIG. 1 shows that the signal contacts 13 are included in a signal module 11 and that the power contacts 14 are included in power modules 12a and 12b. However, depending on the particular application, the electrical connector can include other arrangements of contacts and connector modules. For example, the electrical connector can include only signal contacts or only power contacts. In an electrical connector having only signal contacts 13 or only power contacts 14, each signal/power module can have different arrangements of signal/power contacts 13/14. For example, in an electrical connector having only signal modules, one signal module can include only single-ended contacts and another module can include only signal contacts arranged as differential pairs. It is also possible that either the signal module 11 or the power modules 12a, 12b could include both signal contacts 13 and power contacts 14.

One side of the electrical connector 10 is arranged to be attached to a printed circuit board or other suitable device, as discussed below with respect to FIG. 8. The other side of the electrical connector 10 is arranged to mate with another electrical connector. As shown in FIG. 11, the female electrical connector 10 can be mated with the male electrical connector 60. As seen in a partially assembled state in FIG. 11, both the female electrical connector 10 and the male electrical connector 60 can have a modular design. However, it is also possible that the electrical connectors 10, 60 can be mated with a corresponding electrical connector that does not have a modular design.

FIG. 1 shows an example of an electrical connector 10 according to a preferred embodiment of the present invention. For the sake of clarity, only a portion of the signal contacts 13 are shown. The signal contacts 13 of the signal module 11 of this preferred embodiment are arranged as an array of single ended contacts, but as noted above, the array of contacts could be arranged into single ended, differential pairs, power contacts, radio-frequency contacts, or a combination of different contacts.

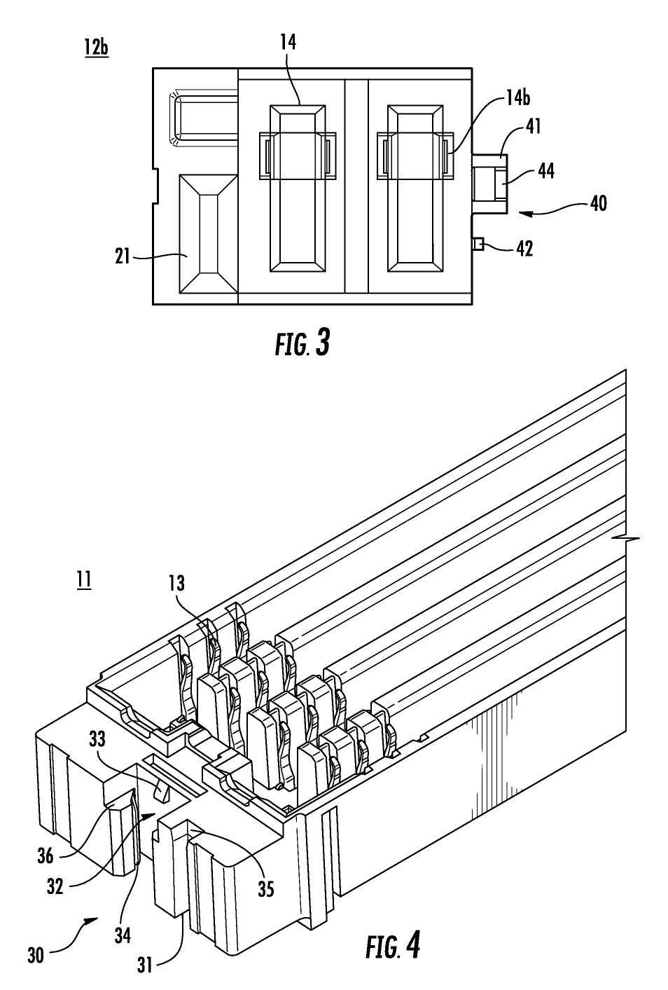

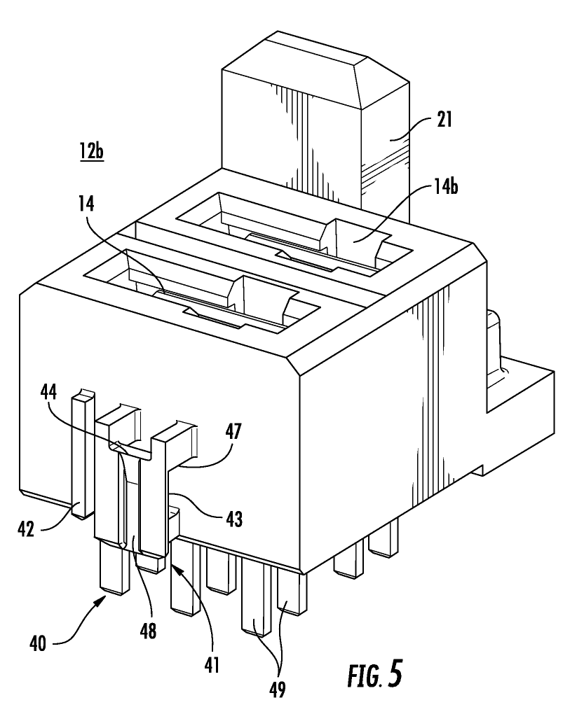

The electrical connector 10 shown in FIG. 1 includes a signal module 11 and a pair of power modules 12a and 12b. The signal module 11 and the power modules 12a and 12b are made from a plastic, a resin, an elastomer, or any other suitable material. Preferably, at least the male mechanical connector 40 is made from a resilient, non-conductive material to allow for the elastic deformation of the male mechanical connector 40 so that male mechanical connector 40 is deformed and then restored to its original shape during the locking of the modules. The signal module 11 and the power modules 12a and 12b are connected to one another at connection regions 20 on the outer circumferential edges of the signal module 11 and power modules 12a and 12b. In this preferred embodiment, the signal module 11 includes a pair of female mechanical connectors 30 on opposite ends, as shown in FIG. 2, and each of the pair of power modules 12a and 12b have a single male mechanical connector 40, as shown in FIG. 3. Also, while FIG. 1 shows female mechanical connectors and male mechanical connectors located on the ends of the connector modules, the female mechanical connectors and male mechanical connectors could also be included on the sides of the connector modules.

However, the present invention is not limited to the arrangement shown in FIG. 1. For example, the electrical connector 10 could be made up of any number and arrangement of connector modules, including all signal modules 11 or all power modules 12a and 12b. Additionally, the connector modules can include female mechanical connectors 30, male mechanical connectors 40, or a combination of female mechanical connectors 30 and male mechanical connectors 40. For example, the signal modules 11 could be provided with male mechanical connectors 40, the power modules 12a and 12b could be provided with female mechanical connectors 30, or both the signal module 10 and the power modules 12a and 12b could be provided with a combination of male mechanical connectors 40 and female mechanical connectors 30.

While FIG. 1 shows the female mechanical connector 30 and male mechanical connector 40 arranged on the ends of the signal module 11 and the power modules 12a and 12b, as is described above, the female mechanical connectors 30 and male mechanical connectors 40 could be located anywhere on the signal modules 11 and power modules 12a and 12b. For example, female mechanical connectors 30 and male mechanical connects 40 could be arranged on the sides of the connector modules rather than just on the ends as is shown in FIG. 1. It is also possible that the female mechanical connectors 30 and the male mechanical connectors 40 are included on a combination on the ends and on the sides, e.g. included on one side and two ends or included on two sides and one end.

The signal module 11 includes a plurality of signal contacts 13 for transmitting and receiving electrical signals through the signal module 11. The power modules 12a and 12b include a plurality of power connection contacts 14 for providing a connection to an electrical power source (not shown). The power modules 12a and 12b include retention indentations 14b for engaging with a corresponding barb (not shown) in the power contacts 14, which helps secure the power contact 14 within the power modules 12a and 12b.

The power modules 12a and 12b further include guide posts 21 for providing proper alignment between the electrical connector 10 and a corresponding connector (not shown). The guide posts 21 could be replaced by or used in combination with any other suitable alignment elements. Also, the guide posts 21 or other suitable alignment elements need not be included on the power modules 12a and 12b. The guide posts 21 or other suitable alignment elements could be included on the signal module 11, on both the power modules 12a and 12b and the signal module 11, or omitted altogether from the modular electrical connector 10 according to preferred embodiments of the present invention.

FIG. 2 shows a top view of the signal module 11 according to a preferred embodiment of the present invention. As can be seen in FIG. 2, opposite ends of the signal module 11 include female mechanical connectors 30. These female mechanical connectors 30 include an alignment slot 31 and locking channel 32. The alignment slot 31 is a groove provided in the end of the signal module 11 and is arranged to ensure the correct alignment of the signal module 11 with a male mechanical connector 40 of another connector module. The correct alignment of the male mechanical connectors 40 and female mechanical connectors 30 is ensured by the engagement of an alignment rail 42 (shown in FIG. 3) of a male mechanical connector 40 with the alignment slot 31 of a female mechanical connector 30. The female mechanical connector 30 also includes various additional ramps and beveled edges (further described below) that act to properly align the male mechanical connector 40 with the female mechanical connector 30.

The locking channel 32 of the female mechanical connector 30 shown in FIG. 2 is generally defined by a “T” or dovetailed shape. However, the locking channel 32 could also have any desirable shape. This locking channel 32 includes a locking tab 33 and a pair of guide projections 34 located on the interior surfaces of the locking channel 32. The locking tab 33 and guide projections 34 of the locking channel 32 engage with corresponding surfaces of the locking projection 41 (shown in FIG. 3) of the male mechanical connector 40 to provide a secure connection between the female mechanical connector 30 and the male mechanical connector 40 and to precisely locate the connector modules with respect to each other.

FIG. 3 shows a top view of the power module 12b according to a preferred embodiment of the present invention. As can be seen in FIG. 3, one end of the power module 12b includes a male mechanical connector 40. The male mechanical connector 40 includes a locking projection 41 and an alignment rail 42. As is described above, the alignment rail 42 of the male mechanical connector 40 engages with the alignment slot 31 of the female mechanical connector 30 to ensure proper alignment between the male mechanical connector 40 and the female mechanical connector 30. As with the female mechanical connector 30, the male mechanical connector 40 also includes various additional ramps and beveled edges (further described below) that act to properly align the male mechanical connector 40 with the female mechanical connector 30.

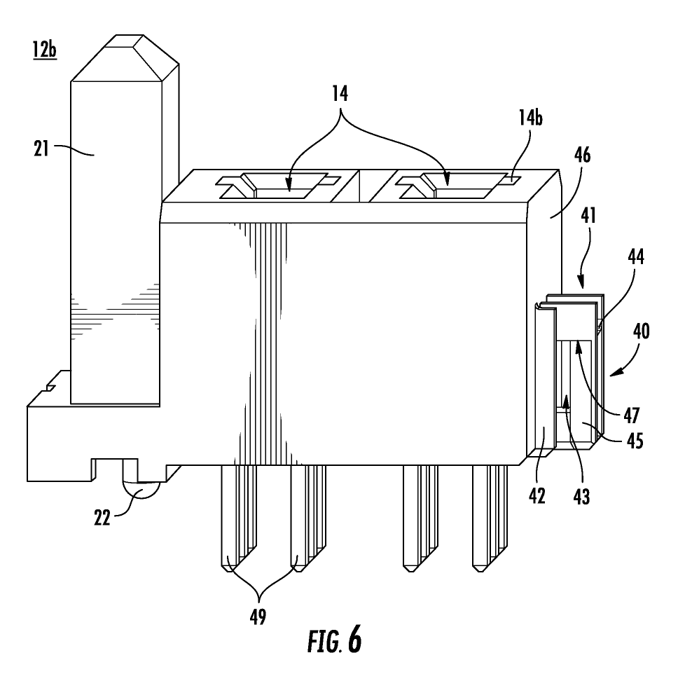

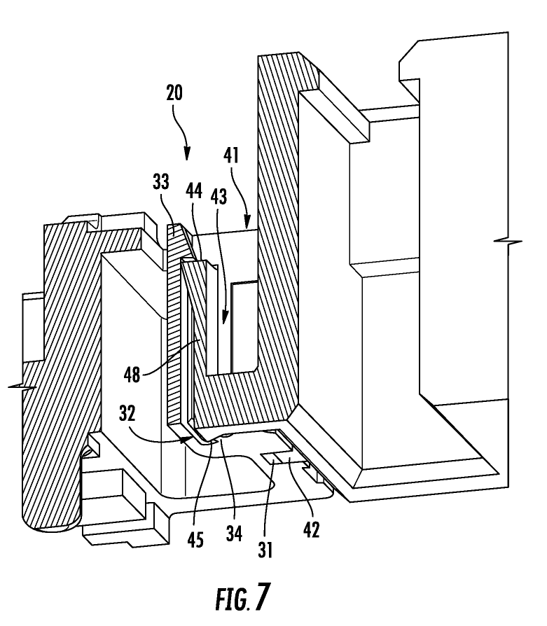

To connect the male mechanical connector 40 to the female mechanical connector 30, the locking projection 41 is inserted into and slid along the locking channel 32 in a first direction until the locking projection 41 and the locking channel 32 lock together. This locking occurs when an engagement edge 44 (shown in FIG. 5) on an attachment arm 48 of the locking projection 41 engages with the lower edge of the locking tab 33 included in the locking channel 32 at the end of travel in the sliding direction. The locking of the engagement edge 44 and the lower edge of the locking tab 33 prevents the connector modules from being separated from each other in a second direction opposite to the first direction. An upper end of the locking channel 32 includes a pair of stopping surfaces 36 (shown in FIG. 4), and the locking projection 41 includes a pair of retaining surfaces 47 (shown in FIG. 6). The end of travel in the first direction between the locking projection 41 and the locking channel 32 is reached when the stopping surfaces 36 come into contact with the retaining surfaces 47 as the locking projection 41 is slid along the locking channel 32. That is, the contact of the retaining surfaces 47 with the stopping surfaces 36 prevents the connector modules from being separated from each other in the first direction.

The arrangement of the locking channel 32 and the locking projection 41 allows the locking projection 41 to be easily inserted and slid along the locking channel 32 with a small force and without the need for any specialized tools. Even though this allows the connector modules to be easily connected to each other, the arrangement of the engagement edge 44 and the lower edge of the locking tab 33 and the arrangement of the retaining surfaces 47 and the stopping surfaces 36 allows for the connector modules to be securely connected so that the connector modules cannot easily be separated from each other. The shapes of the locking channel 32 and the locking projection 41 fix the signal module 11 with respect to the power modules 12a, 12b in the two horizontal axes defined by the length and width of the electrical connector 10. The locking features of the locking tab 33, the engagement edge 44, stopping surfaces 36, and retaining surfaces 47 in the locking channel 32 lock the signal module 11 with respect to the power modules 12a, 12b in the third vertical axis defined by the height of the electrical connector 10 perpendicular to the two horizontal axes. Locating the locking features of the locking tab 33, the engagement edge 44, stopping surfaces 36, and retaining surfaces 47 in the locking channel 32 allows for the miniaturization of the electrical connector 10.

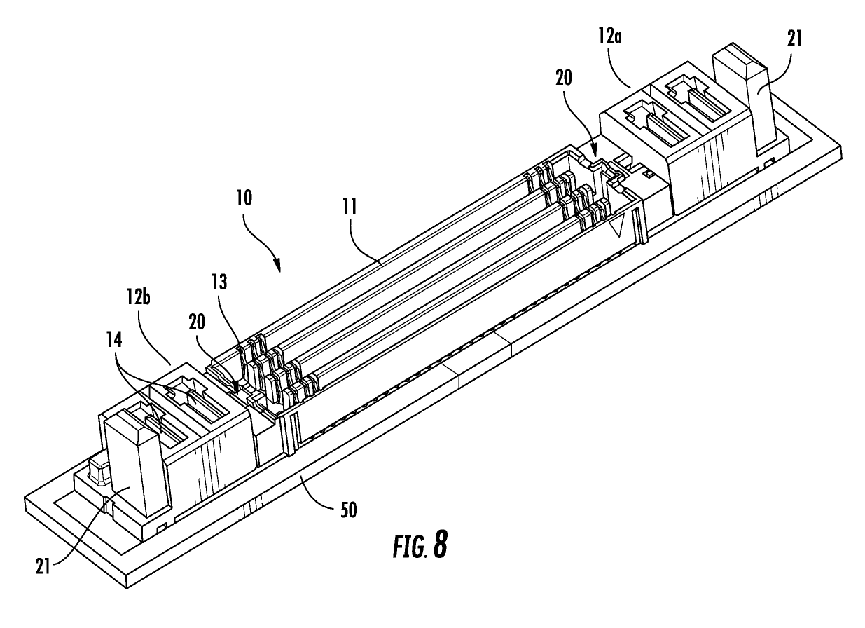

FIG. 4 shows the details of the female mechanical connector 30 of a preferred embodiment of the present invention. The locking tab 33 includes a wedge shape that allows the engagement edge 44 of the locking projection 41 to move past the locking tab 33 as the male mechanical connector 40 is being slid along the locking channel of the female mechanical connector 30. Once the locking projection 41 has reached the end of travel, the engagement edge 44 moves past the locking tab 33, such that the engagement edge 44 fits directly below the locking tab 33 and is locked within the female mechanical connector 30 by the bottom edge of the locking tab 33 (shown in FIG. 7).

The female mechanical connector 30 also includes guide projections 34 that extend from an inner surface of the locking channel 32. An upper portion of these guide projections 34 are preferably tapered from an upper edge of the locking channel 32. This tapering is used in combination with corresponding tapering on guide edges 45 (shown in FIG. 6) of the locking projection 41 of the male mechanical connector 40 to help align the insertion of the locking projection 41 into the locking channel 32. An upper end of the alignment slot 31 preferably includes an angled lead-in 35 that is used in combination with a corresponding angled lead-in in the alignment rail 42 to help align the insertion of the alignment rail 42 into the alignment slot 31. It is also possible to not use any tapering or angled lead-ins or to use tapering or a lead-in on only one connector module. However, greater care will be needed when connecting the connector modules to ensure that the connector modules are properly aligned with each other.

FIG. 5 shows the details of the male mechanical connector 40 of a preferred embodiment of the present invention. As described above, the locking projection 41 includes an engagement edge 44 for ensuring locking between the male mechanical connector 40 and the female mechanical connector 30, once the locking projection 41 has been pushed to the end of its travel.

The locking arrangement is possible due to a resiliency of the attachment arm 48 of the locking projection 41. The resiliency of the attachment arm 48 is due to the void 43 between the locking projection 41 and an end surface 46 of the power module 12b that is created by the attachment arm 48 being connected to the end surface 46 at its upper and lower ends as shown in FIG. 7. The void 43 allows the attachment arm 48 to deform toward the end surface 46 as the locking tab 33 of the female mechanical connector 30 slides along the locking channel 32. After the engagement edge 44 has been pushed past the locking tab 33, the engagement edge 44 snaps back into position because of the resilient properties of the attachment arm 48.

FIG. 6 shows another perspective view of the male mechanical connector 40 of a preferred embodiment of the present invention. The void 43 is between the end surface 46 of the power module 12b and the attachment arm 48. The lower portions of the locking projection 41 and the alignment rail 42 are tapered to help with the alignment of the locking channel 32 and the locking projection 41 when connector modules are connected to each other.

The locking projection 41 includes a pair of guide edges 45 located on either side of the engagement edge 44. These guide edges 45 are tapered in a direction from the bottom to the top of the locking projection 41 to match the “T” or dovetailed shape of the locking channel 32. As with the shape of the locking channel 32, the guide edges 45 can have any desired shape corresponding to the shape of the locking channel. The guide edges 45 engage with the guide projections 34 of the locking channel 32 to apply a restraining force to the sides of the locking projection 41. Because the tapering of the bottoms of the guide edges 45 and the tops of the guide projections 34, proper alignment between the locking channel 32 and the locking projection 41 is easily achieved.

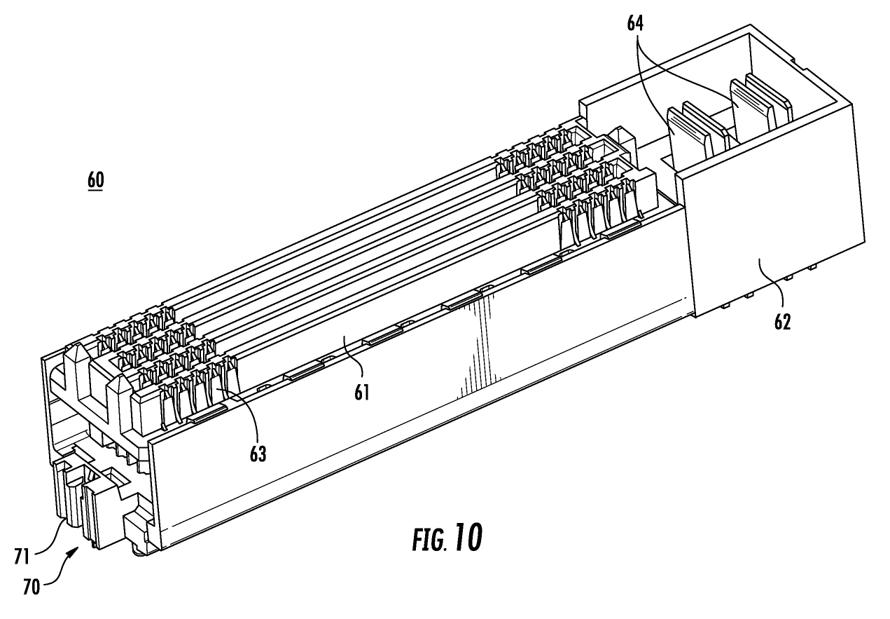

The bottom ends of the power modules 12a and 12b include alignment pins 22 for ensuring the proper alignment of the electrical connector with through holes included in the circuit board 50 shown in FIG. 8. Although the power modules 12a and 12b are shown in the figures as only including a single alignment pin 22, the power modules 12a and 12b could be provided with any desired number of alignment pins 22. Alternatively, the power modules 12a and 12b could also include any other suitable alignment device, or no alignment device at all. Further, the alignment devices, including the alignment pins 22, can also be included on the signal module 11 as shown in FIG. 9. As with the power modules 12a and 12b, the signal module can include no alignment devices.

FIG. 7 shows a sectional view of the connection region 20 between locked female mechanical connector 30 and male mechanical connector 40. The engagement edge 44 has snapped into a position directly below the locking tab 33 of the locking channel 32 because of the resiliency of the attachment arm 48. Because of the opposing flat edges of the locking tab 33 and the engagement edge 44, the locking projection 41 and the locking channel 32 are locked together so that connector modules cannot be moved with respect to each other in the second direction opposite to the first direction in which locking projection 41 is slid along the locking channel 32. As described above, pushing the engagement edge 44 past the locking tab 33 causes the attachment arm 48 to be deformed towards an end surface 46 of the power module 12b. With this arrangement not only is a small assembly force required, but also sufficient attachment strength is provided for the shipping of the modular electrical connector 10 and for the placing of the electrical connector 10 on a circuit board 50 for soldering to the circuit board 50.

FIG. 8 shows a perspective view of the electrical connector 10 of a preferred embodiment of the present invention. The electrical connector 10 is attached to a circuit board 50. The signal contacts 13 and power contacts 14 of the modular electrical connector 10 are preferably attached to the circuit board 50 by soldering. The signal contacts 13 are preferably attached to the circuit board using known surface mount technology (SMT). For example, the signal contacts 13 could be soldered to the circuit board 50 using solder charges as shown in FIG. 9, crimped solder, solder balls, or any other suitable attachment method. The legs 49 of the power contacts 14 as shown in FIG. 6 are preferably inserted into through holes in the circuit board 50 and are soldered to the circuit board 50. Instead of using legs 49 and through holes to attach the power contacts 14 to the circuit board 50, it is also possible to use SMT or any other suitable method to attach the power contacts 14 to the circuit board 50 using any other suitable attachment method, e.g., gluing, heat staking, ultrasonic welding, and mechanically attaching with a separate clip or other similar device.

FIG. 9 shows the bottom of the signal module 11. The signal contacts 13 project from the bottom of the signal module 11. The bottom of the signal contacts 13 include solder 13a that is used to connect the signal contacts 13 to pads (not shown) on the circuit board 50.

The bottom of the signal module 11 also includes alignment pins 22 that fit into corresponding alignment holes (not shown) in the circuit board 50. In the preferred embodiment shown in FIG. 1, the alignment pins 22 are provided asymmetrically about the longitudinal axis of the signal module 11 to ensure the proper polarity of the electrical connector 11 with respect to the circuit board 50. However, the preferred embodiments of the present invention are not limited by this arrangement, and any desirable polarization device can be included, or, alternatively, the electrical connector 11 could not be provided with any polarization devices.

The male electrical connector 60 shown in FIG. 10 is partially assembled in that it includes one signal module 61 and one power module 62 and that, for the sake of clarity, only a portion of the signal contacts 63 are included in the signal module 11. Preferably, the male electrical connector 60 includes another power module on the side opposite to the power module 62 shown in FIG. 10. The signal module 61 shown in FIG. 10 is similar to the elevated height electrical connector shown in U.S. Pat. No. 7,371,129, the entire contents of which are incorporated by reference. However, it is possible to use other suitable signal modules. The signal module 61 preferably includes a female mechanical connector 70 with an alignment slot 71. The female mechanical connector 70 of the signal module 61 of the male electrical connector 60 is similar to the female mechanical connector 30 of signal module 11 of the female electrical connector 10.

As shown in FIG. 10, the male electrical connector 60 preferably also includes a power module 62 with power contacts 64. The power module 62 preferably includes a male mechanical connector (not shown) that is similar to the male mechanical connector 40 of power modules 12a, 12b of the female electrical connector 10. The signal contacts 63 and power contacts 64 of the male electrical connector 60 are arranged such that they form a mechanical and an electrical connection with corresponding signal contacts 13 and power contacts 14 of the female electrical connector 10 when the male electrical connector 60 and the female electrical connector 10 are mated. As shown in FIGS. 1 and 10, the female electrical connector 10 preferably includes all female signal contacts 13 and all male power contacts 14, and the male electrical connector 60 preferably includes all male signal contacts 63 and all male power contacts 64. However, it is also possible that the female electrical connector 10 includes male signal contacts or male power contacts, and it is also possible that the male electrical connector 60 includes female signal contacts or female power contacts. The many modifications discussed above with respect to the female electrical connector 10 can also be made to the male electrical connector 60.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. An electrical connector comprising:
a first connector module having at least one electrical contact and having a male mechanical connector; and
a second connector module having at least one electrical contact and having a female mechanical connector; wherein
the male mechanical connector and the female mechanical connector are arranged to connect the first connector module and the second connector module to one another;
the male mechanical connector includes an alignment rail and a locking projection;
the female mechanical connector includes an alignment slot and a locking channel;
the alignment rail and the alignment slot are engaged with each other; and
the locking projection and the locking channel are engaged with each other.

2. The electrical connector of claim 1, wherein the alignment rail is arranged adjacent to the locking projection on an end surface of the first connector module.

3. The electrical connector of claim 1, wherein:
the male mechanical connector further includes a resilient engagement arm having an engagement edge; and
a void is provided between the engagement edge and an end surface of the first connector module.

4. The electrical connector of claim 1, wherein each of the locking rail and the locking projection include a tapered end.

5. The electrical connector of claim 1, wherein the alignment slot is arranged adjacent to the locking channel on an end surface of the second connector module.

6. The electrical connector of claim 1, wherein:
the locking channel further comprises:
a locking tab located on an inner surface of the locking channel; and
at least one guide projection on the inner surface of the locking channel.

7. The electrical connector of claim 6, wherein the at least one guide projection includes a tapered end.

8. The electrical connector of claim 1, wherein the locking channel has a T or a dovetailed shape.

9. The electrical connector of claim 1, wherein at least one of the first connector module and the second connector module includes a plurality of signal contacts.

10. The electrical connector of claim 9, wherein the plurality of signal contacts is arranged in a single-ended array or in a differential pair array.

11. The electrical connector of claim 1, wherein at least one of the first connector module and the second connector module includes a plurality of power contacts.

12. The electrical connector of claim 6, wherein the locking tab has a wedge shape.

13. The electrical connector of claim 12, wherein an edge of the locking projection engages the edge of the locking tab such the first connector module and the second connector module are prevented from being moved with respect to each other.

14. The electrical connector of claim 1, wherein the locking channel includes at least one stopping surface.

15. The electrical connector of claim 14, wherein at least one retaining surface of the locking projection engages the at least one stopping surface of the locking channel such the first connector module and the second connector module are prevented from being moved with respect to each other.

16. The electrical connector of claim 1, wherein at least one of the first connector module and the second connector module includes at least one guide post arranged to ensure proper alignment with another electrical connector.

17. The electrical connector of claim 1, wherein at least one of the first connector module and the second connector module includes at least one alignment pin arranged to ensure proper alignment with a circuit board.

18. The electrical connector of claim 1, wherein the at least one electrical contact of the first connector module or the second connector module includes solder.

19. The electrical connector of claim 1, wherein the at least one electrical contact of the first connector module or the second connector module includes legs that are arranged to be inserted into through holes of a circuit board.

20. An electrical connector system comprising:
an electrical connector of claim 1; and
a circuit board.
